(19) United States
(12) Patent Application Publication
(10) Pub. No.: US 2012/0262374 A1
(43) Pub. Date: Oct. 18, 2012

(54) REMOTE CONTROL SYSTEM AND METHOD CAPABLE OF SWITCHING DIFFERENT POINTING MODES

(76) Inventors: Pei-Ling Lai, New Taipei City (TW); Pin-Hsien Su, New Taipei City (TW); Sung-Yu Hsieh, New Taipei City (TW); Chun-Chieh Chen, New Taipei City (TW)

(21) Appl. No.: 13/398,810

(22) Filed: Feb. 16, 2012

(30) Foreign Application Priority Data
Apr. 13, 2011 (TW) 100112785

(51) Int. Cl. G09G 5/08

(52) U.S. Cl. 345/158

(57) ABSTRACT

The present relates to a remote control method and a remote control system capable of switching different pointing modes. The remote control method includes a first wireless transmission module transmitting a first wireless signal with a first pointing mode code to an electronic device, a second wireless transmission module transmitting a second wireless signal with a second pointing mode code to the electronic device, and the electronic device performing movement of an icon at a first pointing mode or at a second pointing mode according to the received first pointing mode code or the received second pointing mode code and pointing mode relation information.

### BACKGROUND OF THE INVENTION

1. Field of the Invention

The present invention relates to a remote control system and a method capable of switching different pointing mode, and more particularly, to a remote control system and a method capable of switching different pointing modes according to different pointing mode codes transmitted from different wireless transmission modules of a remote control and received by an electronic device.

2. Description of the Prior Art

Recently, in order to meet the demands for televisions with more and more functions (such as a network television) or for digital home theaters such as a set-top box, a multi-media player, a blue-ray player and so on, various new remote controls have been developed. For example, as for a network navigator built in the set-top box, it needs a pointing interface for operating the network navigator. While there are demands for searching webpages or keying in a website address, it needs an input interface. Some products are equipped with a wireless mouse and a keyboard for non-directional pointing operation and input, and some products have devices equipped with non-directional pointing components such as a touch panel or a trackball. However, if a user cannot switch operating direction of the remote control or control moving direction of a pointing cursor on the television according to how the remote control is held by the user, it causes inconsistency between the operating direction of the remote control and the moving direction of the pointing cursor on the television, so as to result in trouble in use. Thus, it becomes an important issue for the remote control system and the remote control method to be more operable and user-friendly.

### SUMMARY OF THE INVENTION

The present invention provides a remote control system and a method capable of switching different pointing modes for solving above drawbacks.

According to the claimed invention, a remote control system includes a remote control and an electronic device. The remote control includes a first wireless transmission module, a second wireless transmission module, and a control module. The first wireless transmission module is used for transmitting a first wireless signal, and the first wireless signal includes a first pointing mode code. The second wireless transmission module is used for transmitting a second wireless signal, and the second wireless signal includes a second pointing mode code. The control module is coupled to the first wireless transmission module and the second wireless transmission module for controlling the first wireless transmission module or the second wireless transmission module to respectively output the first pointing mode code or the second pointing mode code. The electronic device includes a display module for displaying an icon, a memory module for storing pointing mode relation information corresponding to the first pointing mode code and the second pointing mode code, a third wireless transmission module for receiving the first pointing mode code transmitted from the first wireless transmission module or the second pointing mode code transmitted from the second wireless transmission module, and a logic unit coupled to the display module, the memory module and the third wireless transmission module for performing movement of the icon displayed on the display module at a first pointing mode or at a second pointing mode according to the first pointing mode code or the second pointing mode code received by the third wireless transmission module and the pointing mode relation information stored by the memory module.

According to the claimed invention, a remote control method capable of switching different pointing modes includes a first wireless transmission module of a remote control transmitting a first wireless signal to an electronic device by wireless transmission technology, wherein the first wireless transmission signal comprises a first pointing mode code; a second wireless transmission module of the remote control transmitting a second wireless signal to the electronic device by wireless transmission technology, wherein the second wireless transmission signal includes a second pointing mode code; and the electronic device performing movement of an icon at a first pointing mode or at a second pointing mode according to the first pointing mode code or the second pointing mode code and pointing mode relation information.

In summary, the present invention mainly utilizes the different pointing mode codes transmitted from the different wireless transmission modules of the remote control and received by an electronic device to determine the orientation of the remote control, so as to determine that the present invention is capable of switching the different pointing modes according to different orientation of the remote control. In such a manner, the present invention is capable of assembling operations of multiple pointing modes (such as vertically-oriented operation, horizontally-oriented operation and so on) according to demands of the system by the same one pointing interface neither using directional keys of up, down, left and right nor non-directional pointing components for interfaces of the different pointing modes. Furthermore, after the remote control is turned on, the lower pointing interface can be cooperatively used with the upper pointing interface for doing upward, downward, leftward and rightward directional operations accurately. Accordingly, the present invention provides a remote control system and a remote control method with being more operable and user-friendly.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a diagram of a remote control system according to an embodiment of the present invention.

FIG. 2 is a functional block diagram of the remote control system according to the embodiment of the present invention.

FIG. 3 and FIG. 4 are respectively diagrams of a remote control in different states according to the embodiment of the present invention.

FIG. 5 to FIG. 10 are respectively internal structural diagrams illustrating that a first module and a second module slide relatively to different positions according to the embodiment of the present invention.

FIG. 11 is a flowchart of a remote control method for the remote control system to switch different pointing modes according to the embodiment of the present invention.

### DETAILED DESCRIPTION

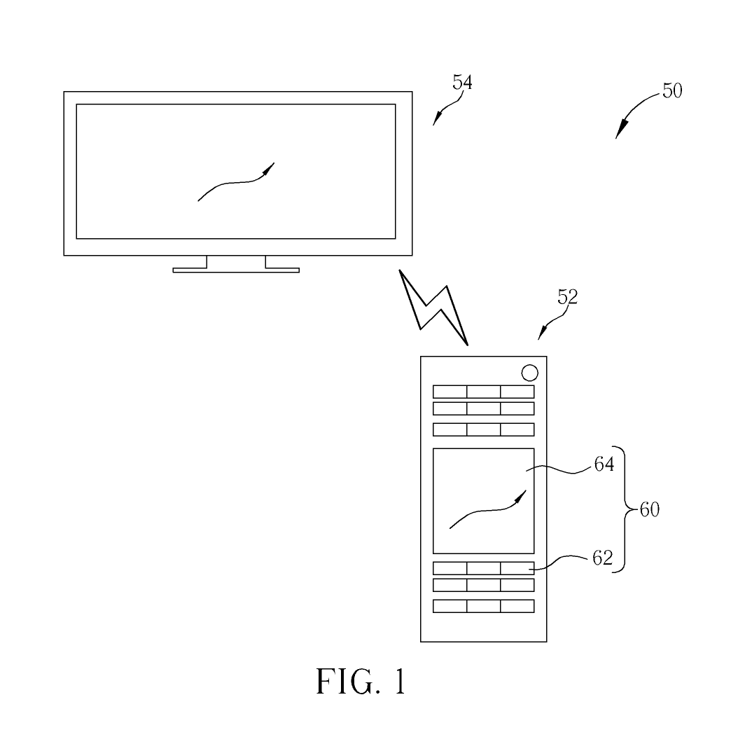

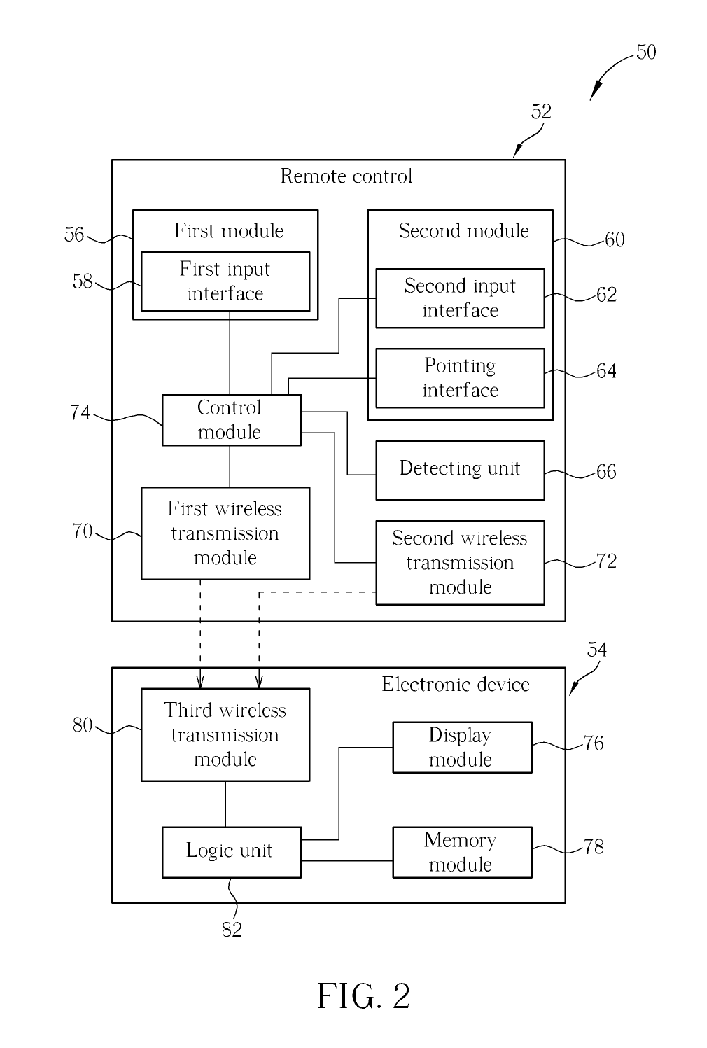

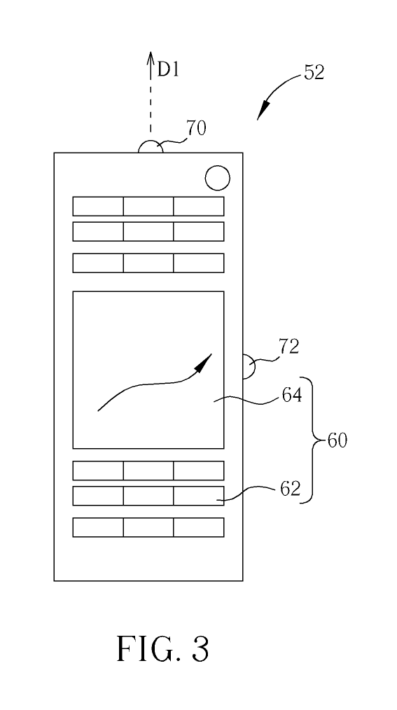

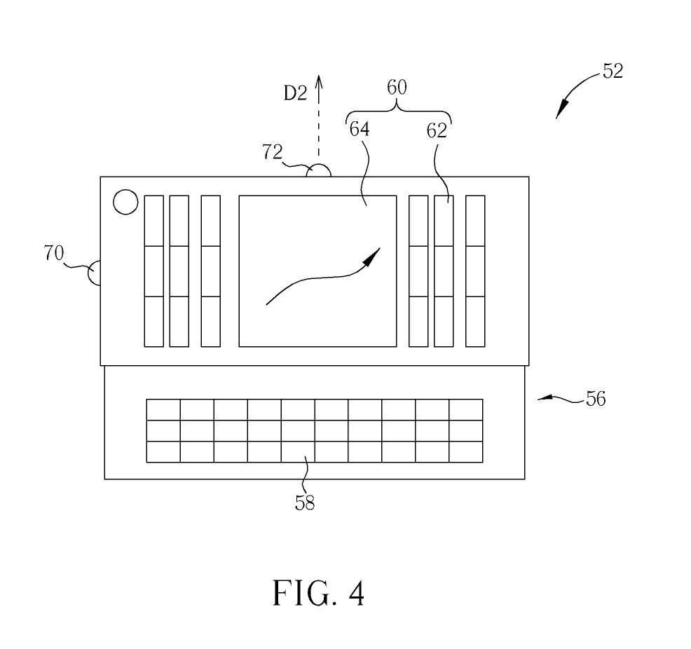

Please refer to FIG. 1 and FIG. 2. FIG. 1 is a diagram of a remote control system 50 according to an embodiment of the present invention. FIG. 2 is a functional block diagram of the remote control system 50 according to the embodiment of the present invention. The remote control system 50 includes a remote control 52 for remotely controlling an electronic device 54. The electronic device 54 can be a television device (e.g. a network television), a computer device and so on. Please refer to FIG. 1 to FIG. 4. FIG. 3 and FIG. 4 are respectively diagrams of the remote control 52 in different states according to the embodiment of the present invention. The remote control 52 includes a first module 56 whereon a first input interface 58 is disposed. For example, the first input interface 58 can include a plurality of keys for a user to perform searching function or inputting a website address. The remote control 52 includes a second module 60 installed on a side of the first module 56 in a slidable manner relative to the first module 56. A second input interface 62 and a pointing interface 64 are disposed on the second module 60. For example, the second input interface 62 can include a plurality of multi-media control keys such as a selection key, a volume key, a play key and so on. The pointing interface 64 can execute directional control by non-directional pointing components, such as a touch control panel, a joystick, a trackball and so on, or by four-direction keys.

In FIG. 3, the first module 56 and the second module 60 slide relatively to a first position. In other words, the second module 60 and the first module 56 are in a closed position. In FIG. 4, the first module 56 and the second module 60 slide relatively to a second position. In other words, the second module 60 and the first module 56 are in an open position. In general, the second input interface 62 of the second module 60 is equipped with the frequently used multi-media control keys, and the first input interface 58 of the first module 56 is equipped with rarely used keys on a keyboard. Accordingly, when the user only uses the remote control 52 to remotely control multi-media playing, the second module 60 can be slid to the first position relative to the first module 56 and only the second input interface 62 is operated. Consequently, it can reduce volume occupied by the remote control 52. When the keys on the keyboard is needed for data input, the second module 60 can be slid to the second position relative to the first module 56, so as to expose the first input interface 58 for the user to input data.

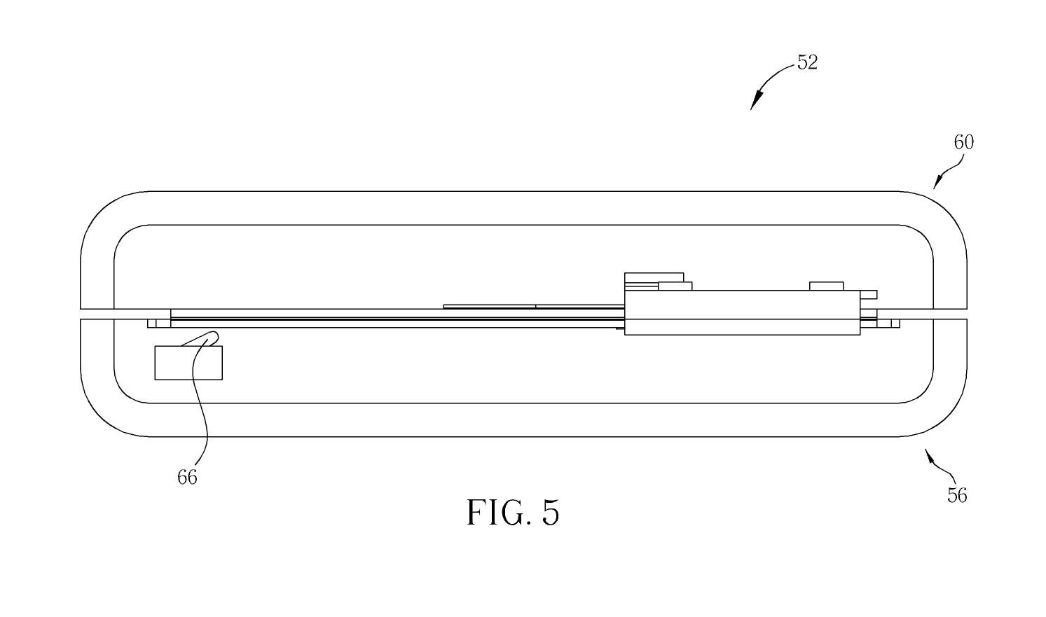

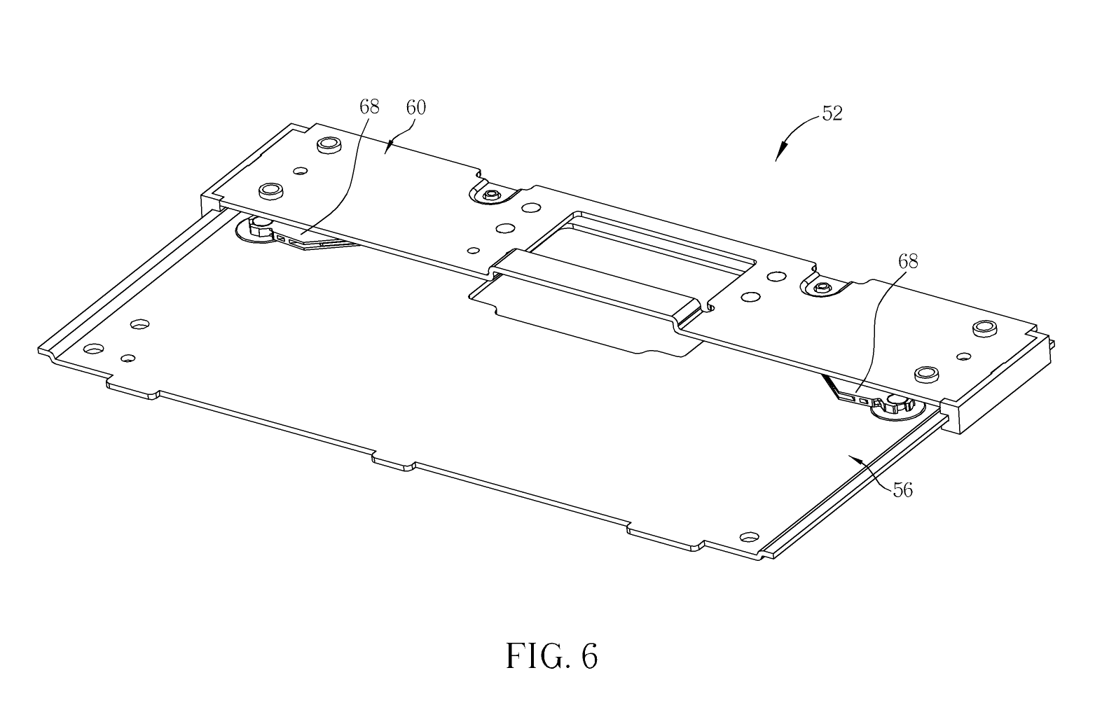

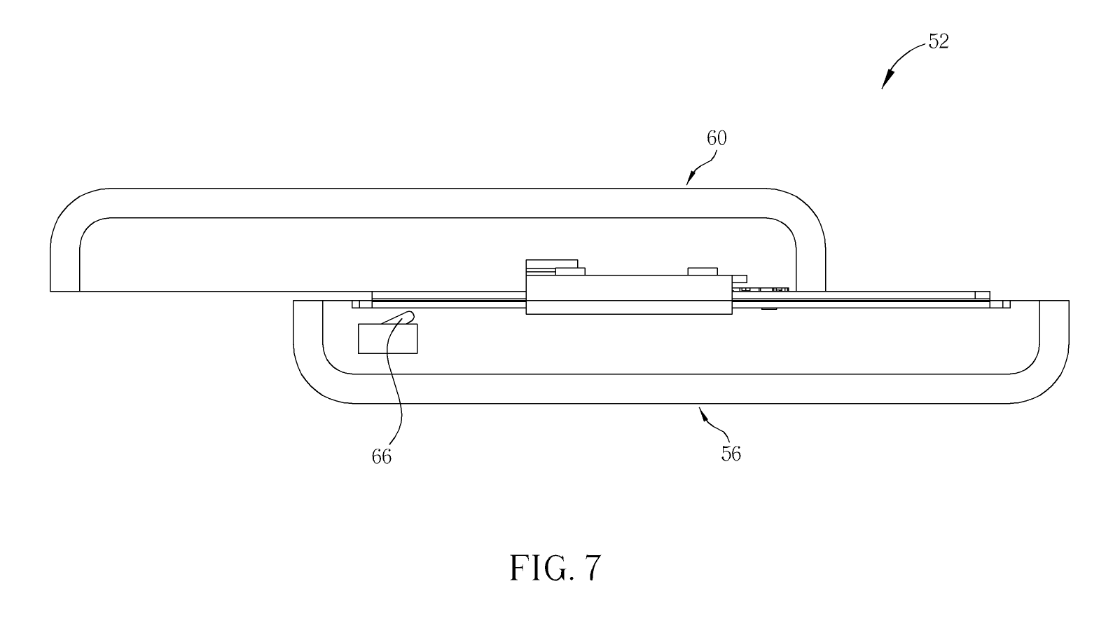

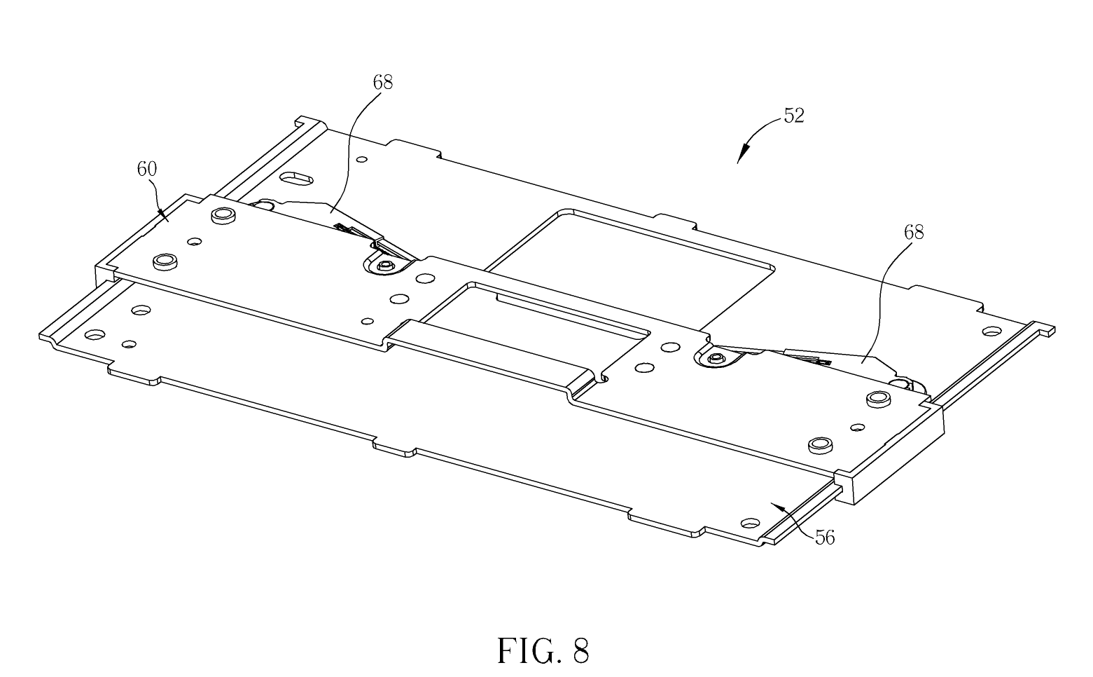

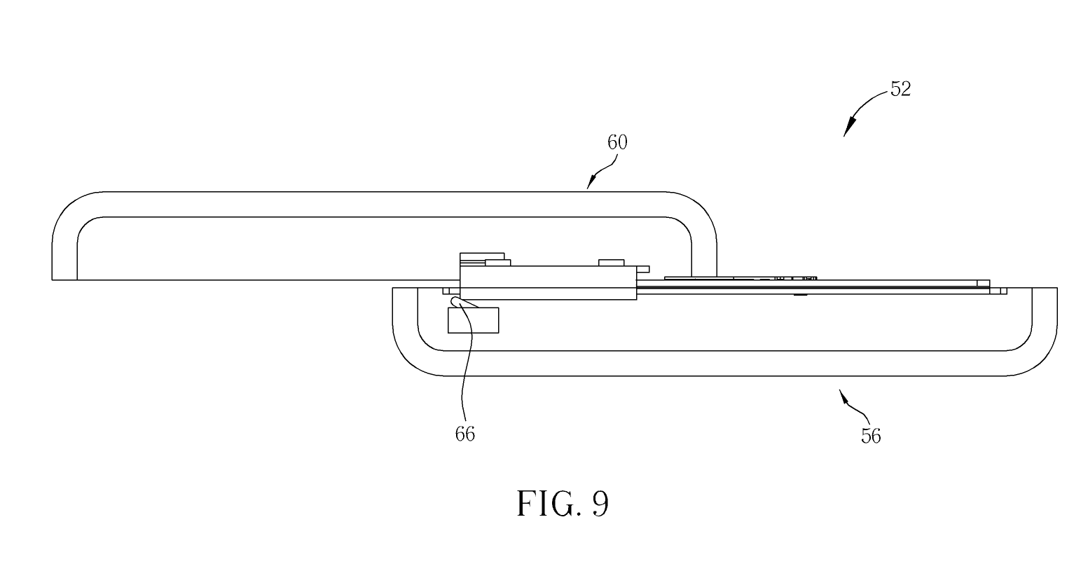

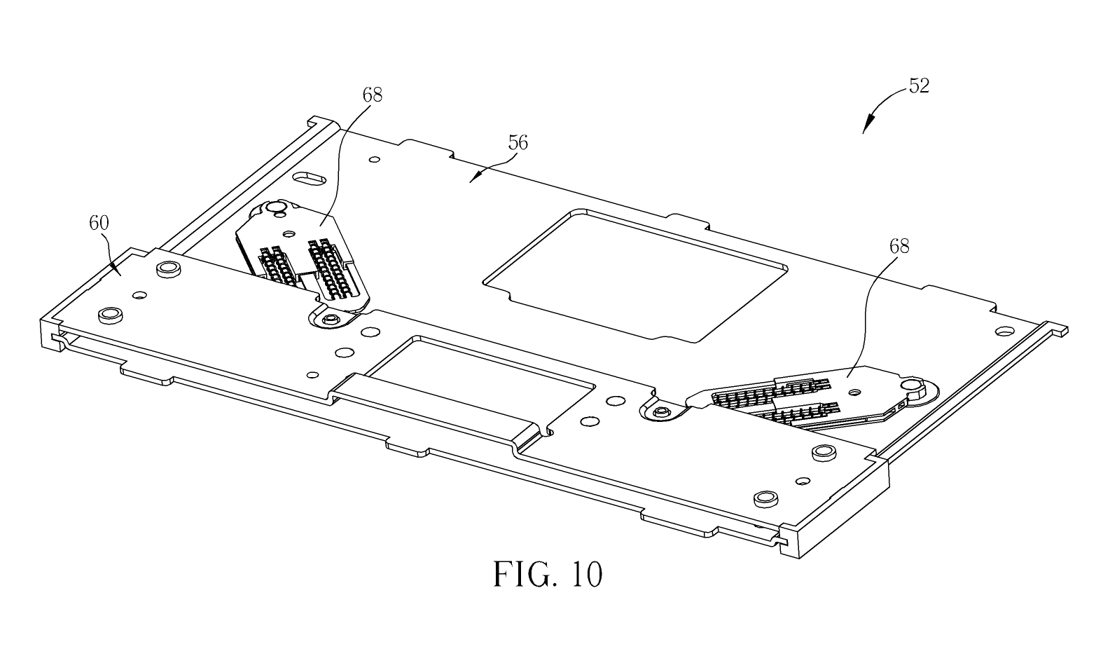

Furthermore, the remote control 52 further includes a detecting unit 66 for detecting a relative position between the first module 56 and the second module 60, so as to generate a detecting signal correspondingly. Please refer to FIG. 5 to FIG. 10. FIG. 5 to FIG. 10 are respectively internal structural diagrams illustrating that the first module 56 and the second module 60 slide relatively to different positions according to the embodiment of the present invention. For example, the detecting unit 66 can be a switch which is pushed to be activated so as to generate the detecting signal when the first module 56 and the second module 60 slide relatively to each other. Two driving modules 68 (such as torsion springs) can be used for sliding the first module 56 and the second module 60. As the second module 60 is pushed from the closed position of the first module 56 and the second module 60 (as shown in FIG. 5 and FIG. 6) via a half-open position of the first module 56 and the second module 60 (as shown in FIG. 7 and FIG. 8) and finally to the open position of the first module 56 and the second module 60 (as shown in FIG. 9 and FIG. 10), a structural component connected to the second module 60 can actuate the detecting unit 66, so as to generate the detecting signal correspondingly. In such a manner, change of the relative position between the first module 56 and the second module 60 can be detected. In other words, the detecting unit 66 can be used for detecting which of the first position or the second position the first module 56 slides relative to the second module 60, so as to generate the detecting signal correspondingly. Besides the above-mentioned embodiment, the present invention can utilize other detecting mechanism such as an optical sensor or a magnetic spring switch, so as to detect the relative position between the first module 56 and the second module 60. Mechanisms capable of detecting the relative position between the first module 56 and the second module 60 are within the scope of the present invention.

Please refer to FIG. 2 again. The remote control 52 further includes a first wireless transmission module 70 for transmitting a first wireless signal. The first wireless signal includes a first pointing mode code. The remote control 52 further includes a second wireless transmission module 72 for transmitting a second wireless signal. The second wireless signal includes a second pointing mode code. The remote control 52 further includes a control module 74 coupled to the detecting unit 66, the first wireless transmission module 70 and the second wireless transmission module 72. The control module 74 is used for controlling the first wireless transmission module 70 or the second wireless transmission module 72 to respectively output the first pointing mode code or the second pointing mode code and for outputting a signal corresponding to the detecting signal.

In addition, the electronic device 54 includes a display module 76 for displaying an icon. For example, the display module 76 can be a display monitor for displaying the icon such as a cursor. The electronic device 54 further includes a memory module 78 for storing the pointing mode code and pointing mode relation information of the pointing interface 64. Which of the pointing modes that the icon displayed by the display module 76 and the pointing interface 64 correspond to can be determined by the pointing mode relation information when the electronic device 54 receives the first pointing mode code or the second pointing mode code. The electronic device 54 further includes a third wireless transmission module 80 for receiving the first pointing mode code or the second pointing mode code respectively transmitted from the first wireless transmission module 70 or the second transmission module 72. The electronic device 54 further includes a logic unit 82 coupled to the display module 76, the memory module 78 and the third transmission module 80. The logic unit 82 is used for performing movement of the icon displayed on the display module 76 according to the first pointing mode code or the second pointing mode code received by the third wireless transmission module 80, the signal corresponding to the detecting signal received by the third transmission module 80 and the pointing mode relation information stored by the memory module 78. For example, the movement of the icon displayed by display module 76 is performed at a first pointing mode or at a second pointing mode, wherein the first pointing mode can differ from the second pointing mode by 90 degrees.

Furthermore, the first wireless transmission module 70 and the second wireless transmission module 72 can respectively transmit wireless signals to the third transmission module 80 by infrared transmitting technology. The infrared transmitting technology has constraints for direction and distance. For example, an infrared signal projected at a projecting angle of 0 degree hardly decays, but the infrared signal will increasingly decay as the projecting angle grows. Accordingly, the first wireless transmission module 70 and the second wireless transmission module 72 can be disposed on two sides perpendicular to each other of the remote control 52 due to directionality characteristic of the infrared. Thus, the first wireless transmission module 70 transmits the first wireless signal in a first direction D1, and the second wireless transmission module 72 transmits the second wireless signal in a second direction D2, wherein the first direction D1 can differs from the second direction D2 by substantially 90 degrees. The remote control 52 can be in a vertically-oriented state when the third transmission module 80 of the electronic device 54 receives the first pointing mode code transmitted from the first wireless transmission module 70, and the remote control 52 can be in a horizontally-oriented state when the third transmission module 80 receives the second pointing mode code transmitted from the second wireless transmission module 72, wherein the vertically-oriented state can differs from the horizontally-oriented state by substantially 90 degrees. Besides, the first wireless transmission module 70 and the second wireless transmission module 72 can be designed to transmit optical signals or audio signals with different frequencies to the third transmission module 80, so as to distinguish the wireless signal received by the third transmission module 80 and transmitted from the first wireless transmission module 70 or the second wireless transmission module for determining whether the remote control 52 is vertically-oriented or horizontally-oriented.

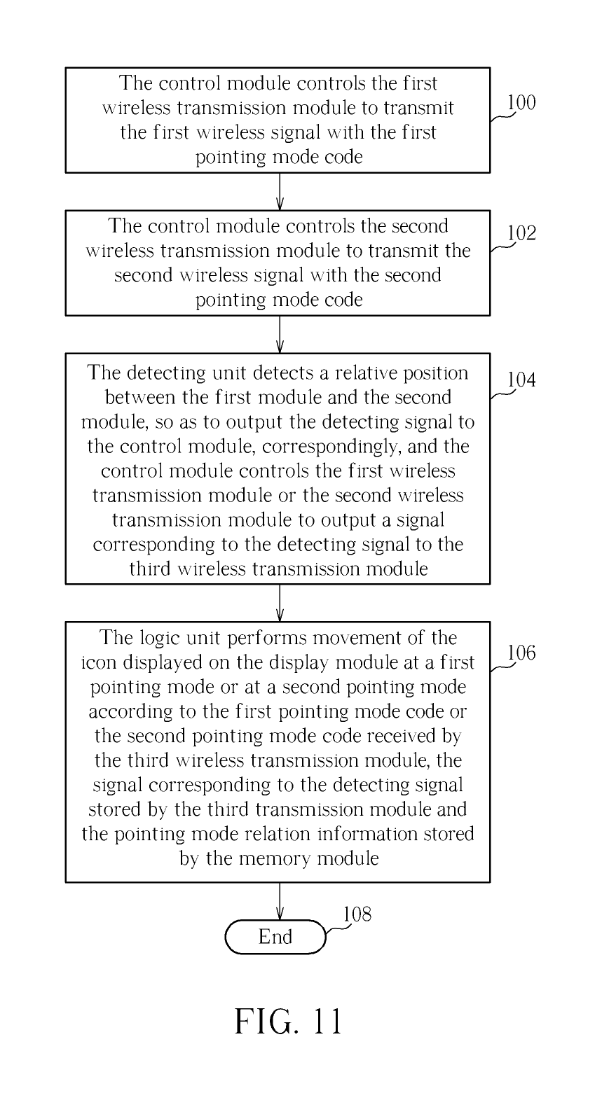

Please refer to FIG. 11. FIG. 11 is a flow chart of a remote control method for the remote control system 50 to switch different pointing modes according to the embodiment of the present invention. The remote control method includes following steps:

Step 100: The control module 74 controls the first wireless transmission module 70 to transmit the first wireless signal with the first pointing mode code by wireless transmission technology according to the operation of the pointing interface 64 performed by the user.

Step 102: The control module 74 controls the second wireless transmission module 72 to transmit the second wireless signal with the second pointing mode code by wireless transmission technology according to the operation of the pointing interface 64 performed by the user.

Step 104: The detecting unit 66 of the remote control 52 detects a relative position between the first module 56 and the second module 60, so as to output the detecting signal to the control module 74, correspondingly, and the control module 74 controls the first wireless transmission module 70 or the second wireless transmission module 72 to output a signal corresponding to the detecting signal to the third transmission module 80 of the electronic device 54.

Step 106: The logic unit 82 performs movement of the icon displayed on the display module 76 at a first pointing mode or at a second pointing mode according to the first pointing mode code or the second pointing mode code received by the third wireless transmission module 80, the signal corresponding to the detecting signal stored by the third transmission module 80 and the pointing mode relation information stored by the memory module 78.

Step 108: End.

More detailed description for the above-mentioned steps is provided as follows. No matter the remote control 52 is vertically-oriented or horizontally-oriented, the control module 74 can control the first wireless transmission module 70 and the second wireless transmission module 72 to respectively transmit the first wireless signal with the first pointing mode code and the second wireless signal with the second pointing mode code by the wireless transmission technology according to the operation of the pointing interface 64 performed by the user. For example, the first pointing mode code and the second pointing mode code with vertically-oriented and horizontally-oriented index respectively can be implemented into the first wireless signal and the second wireless signal in the first direction D1 (in the vertically-oriented state) and in the second direction D2 (in the horizontally-oriented state). As the third transmission module 80 of the electronic device 54 receives the wireless signals transmitted from the first wireless transmission module 70 or the second wireless transmission module 72, which of the wireless transmission modules for transmitting the signal can be determined by the first pointing mode code or the second pointing mode code received by the third transmission module 80. Afterwards, the remote control 52 can be determined to be vertically-oriented or horizontally-oriented, and thus the information that the remote control 52 is in the vertically-oriented state or in the horizontally-oriented state can be in accordance with the pointing modes of the pointing interface 64.

For example, take an infrared transmission signal for example, if an infrared command 00ff02fd is defined as playing in the electronic device 54, the first wireless transmission module 70 can be defined to transmit the infrared command 00ff02fd, and the second wireless transmission module 72 can be defined to transmit an infrared command 01ff02fd. Further, the electronic device 54 can execute corresponding playing function whether the infrared command 00ff02fd or the infrared command 01ff02fd is received by the electronic device 54. If the infrared command 00ff02fd is defined that the cursor displayed by the display module 76 moves leftward by 200 pixels in the electronic device 54, the first wireless transmission module 70 can defined to transmit the infrared command 00ff02fd, and the second wireless transmission module 72 can be defined to transmit the infrared command 01ff02fd. When the electronic device 54 receives the infrared command 00ff02fd, the remote control 52 can be determined to be vertically-oriented. As a result, the logic unit 82 can control the cursor displayed by the display module 76 to move leftward by 200 pixels (corresponding to the first pointing mode) . When the electronic device 54 receives the infrared command 01ff02fd, the remote control 52 can be determined to be horizontally-oriented. As a result, the logic unit 82 can control the cursor displayed by the display module 76 to move upward by 200 pixels (corresponding to the second pointing mode). In such a manner, the icon displayed by the display module 76 can perform the movement exactly corresponding to the orientation directions of the remote control 52. By determining the orientation of the remote control 52, the operating directions of the pointing interface 64 can be switched for avoiding inconsistency of the operating direction of the pointing interface 64 and the moving direction of the icon displayed on the display module 76, so as to cause difficulty in use. In addition, the logic unit 82 of the electronic device 54 can perform the movement of the icon displayed on the display module 76 at the first pointing mode or the second pointing mode according to receiving times of the first pointing mode code or the second pointing mode code and the pointing mode relation information stored by the memory module 78. In other words, if the wireless signals are reflected by indoor objects, the wireless signals in two directions respectively transmitted from the first wireless transmission module 70 and the second wireless transmission module 72 will be received by the third transmission module 80 of the electronic device 54. The logic unit 82 can determine the orientation state of the remote control 52 by the pointing mode code that has been received by the third transmission module 80 more times.

In addition to the aforesaid method that utilize the pointing mode code to determine whether the remote control 52 is in the vertically-oriented state or in the horizontally-oriented state, the relative position between the first module 56 and the second module 60 can be selectively utilized to determine the pointing mode of the pointing interface 64. The detecting unit 66 of the remote control 52 can detect the relative position between the first module 56 and the second module 60 by utilizing the aforesaid mechanism, so as to output the detecting signal to the control module 74, correspondingly. Furthermore, the control module 74 can control the first wireless transmission module 70 or the second wireless transmission module 72 to output the signal corresponding to the detecting signal to the third transmission module 80 of the electronic device 54. Accordingly, the state that the first module 56 and the second module 60 are open or closed can be used for assisting to determine the pointing mode of the pointing interface 64.

For example, when the first module 56 and the second module 60 slide relatively to the first position and the remote control 52 is vertically-oriented, the icon displayed by the display module 76 can be moved at the first pointing mode. When the first module 56 and the second module 60 slide relatively to the second position and the remote control 52 is horizontally-oriented, the icon displayed by the display module 76 can be moved at the second pointing mode. When the first module 56 and the second module 60 slide relatively to the second position and the remote control 52 is vertically-oriented, the icon displayed by the display module 76 can be moved at the first pointing mode. When the first module 56 and the second module 60 slide relatively to the first position and the remote control 52 is horizontally-oriented, the icon displayed by the display module 76 can be moved at the first pointing mode. In other words, only when the first module 56 and the second module 60 slide relatively to the second position (the state that the first module 56 and the second module 60 are open) and the remote control 52 is horizontally-oriented, the logic unit 82 will perform the movement of the icon displayed by the display module 76 at the second pointing mode. Otherwise, the logic unit 82 will perform the movement of the icon displayed by the display module 76 at the first pointing mode. That is, when the user slides the first module 56 and the second module 60 relatively to the second position (the state that the first module 56 and the second module 60 are open) and the remote control 52 is horizontally-oriented, the electronic device 54 switches the pointing mode of the pointing interface 64 to the second pointing mode. In this mode, the user can operate the pointing interface 64 by getting the remote control 52 be horizontally-oriented, and the icon displayed by the display module 76 can move exactly corresponding to the user's operation. In contrast, when the user slides the first module 56 and the second module 60 relatively to the first position (the state that the first module 56 and the second module 60 are closed) and the remote control 52 is vertically-oriented, the electronic device 54 switches the pointing mode of the pointing interface 64 to the first pointing mode. In this mode, the user can operate the pointing interface 64 by getting the remote control 52 be vertically-oriented, and the icon displayed by the display module 76 can move exactly corresponding to the user's operation, that is, the first pointing mode differs from the second pointing mode by 90 degrees on the same pointing interface 64. It should be noticed that the determining condition is not limited to those mentioned above, and it depends on practical demands. As mentioned above, the state that the first module 56 and the second module 60 are open or closed can be selectively used for assisting to determine the pointing mode of the pointing interface 64. In other words, the pointing mode code received by the electronic device 54 can be solely used for determining the remote control 52 to be vertically-oriented or horizontally-oriented and for determining the pointing mode of the pointing interface 64. The way of design depends on practical demands.

On the other hand, when the user turn on the remote control 52 (the first module 56 and the second module 60 slide relatively to the open position), it means the remote control 52 will be horizontally-oriented for the user to execute typing on the first input interface 58. Furthermore, in order to determine whether the aforesaid motion is an error motion, the first pointing mode code or the second pointing mode code transmitted from the first wireless transmission module 70 or the second wireless transmission module 72 and received by the electronic device 54 can be used as detecting mechanism for sensing the state of the remote control 52 that the user needs to perform. In other words, only when the first module 56 and the second module 60 slide relatively to the open position and the remote control 52 is horizontally-oriented, the pointing mode of the pointing interface 64 will be switched to the second pointing mode, that is, an operating mode for the user to perform upward, downward, leftward and rightward when the remote control 52 is horizontally-oriented. Otherwise, the pointing mode of the pointing interface 64 is switched to the first pointing mode, that is, an operating mode for the user to perform upward, downward, leftward and rightward when the remote control 52 is vertically-oriented. In such a manner, the operating direction on the pointing interface 64 can be switched correspondingly for avoiding the operating direction that the user performs on the pointing interface 64 from being inconsistent with the moving direction of the icon displayed on the display module 76, so as to cause difficulty in use. As for matching condition among the open-closed state of the remote control 52, the orientation of the remote control 52 and different pointing modes can not be limited to those mentioned above, and it depends on practical demands.

Compared with the prior art, the present invention mainly utilizes the different pointing mode codes transmitted from the different wireless transmission modules of the remote control and received by an electronic device to determine the orientation of the remote control, so as to determine that the present invention is capable of switching the different pointing modes according to different orientation of the remote control. In such a manner, the present invention is capable of assembling operations of multiple pointing modes (such as vertically-oriented operation, horizontally-oriented operation and so on) according to demands of the system by the same one pointing interface neither using directional keys of up, down, left and right nor non-directional pointing components for interfaces of the different pointing modes. Furthermore, after the remote control is turned on, the lower pointing interface can be cooperatively used with the upper pointing interface for doing upward, downward, leftward and rightward directional operations accurately. Accordingly, the present invention provides a remote control system and a remote control method with being more operable and user-friendly.

Those skilled in the art will readily observe that numerous modifications and alterations of the device and method may be made while retaining the teachings of the invention.

What is claimed is:

1. A remote control system, comprising:
a remote control, comprising:
a first wireless transmission module for transmitting a first wireless signal, the first wireless signal comprising a first pointing mode code;
a second wireless transmission module for transmitting a second wireless signal, the second wireless signal comprising a second pointing mode code; and
a control module coupled to the first wireless transmission module and the second wireless transmission module for controlling the first wireless transmission module or the second wireless transmission module to respectively output the first pointing mode code or the second pointing mode code; and
an electronic device, comprising:
a display module for displaying an icon;
a memory module for storing pointing mode relation information corresponding to the first pointing mode code and the second pointing mode code;
a third wireless transmission module for receiving the first pointing mode code transmitted from the first wireless transmission module or the second pointing mode code transmitted from the second wireless transmission module; and
a logic unit coupled to the display module, the memory module and the third wireless transmission module for performing movement of the icon displayed on the display module at a first pointing mode or at a second pointing mode according to the first pointing mode code or the second pointing mode code received by the third wireless transmission module and the pointing mode relation information stored by the memory module.

2. The remote control system of claim 1, wherein the first wireless transmission module is used for transmitting a first wireless signal in a first direction, the second wireless transmission module is used for transmitting a second signal in a second direction, the remote control is in a vertically-oriented state when the third wireless transmission module receives the first pointing mode code transmitted from the first wireless transmission module, and the remote control is in a horizontally-oriented state when the third wireless transmission module receives the second pointing mode code transmitted from the second wireless transmission module.

3. The remote control system of claim 2, wherein the first direction substantially differentiates from the second direction by 90 degrees, the vertically-oriented state substantially differentiates from the horizontally-oriented state by 90 degrees, and a performing direction of the first pointing mode code differentiates from that of the second pointing mode code by 90 degrees.

4. The remote control system of claim 2, wherein the remote control further comprises:
a first module whereon a first input interface is disposed;
a second module installed on a side of the first module in a manner capable of sliding relative to the first module, a second input interface and a pointing interface are disposed on the second module; and
a detecting unit coupled to the control module for detecting a relative position between the first module and the second module, so as to generate a detecting signal;
wherein the control module is further used for controlling the first wireless transmission module or the second wireless transmission module to output a signal corresponding to the detecting signal to the third wireless transmission module, and the logic unit is further used for performing the movement of the icon displayed on the display module at the first pointing mode or at the second pointing mode according to the first pointing mode code or the second pointing mode code received by the third wireless transmission module, the signal corresponding to the detecting signal received by the third wireless transmission module and the pointing mode relation information stored by the memory module.

5. The remote control system of claim 4, wherein the detecting unit is a switch being pushed to generate the detecting signal when the first module and the second module move relatively.

6. The remote control system of claim 4, wherein the remote control further comprises at least one driving module for driving the second module to slide relative to the first module.

7. The remote control system of claim 6, wherein the driving module is a torsion spring.

8. The remote control system of claim 4, wherein the detecting unit is used for detecting a first position or a second position where the second module slides relative to the first module, so as to generate the detecting signal, wherein the first position is a position where the second module and the first module are closed relatively, and the second position is a position where the second module and the first module are open relatively.

9. The remote control system of claim 8, wherein the logic unit is used for performing the movement of the icon displayed on the display module at the first pointing mode when the detecting unit detects the first position where the second module slides relative to the first module and the remote control is in the vertically-oriented state.

10. The remote control system of claim 8, wherein the logic unit is used for performing the movement of the icon displayed on the display module at the second pointing mode when the detecting unit detects the second position where the second module slides relative to the first module and the remote control is in the horizontally-oriented state.

11. The remote control system of claim 8, wherein the logic unit is used for performing the movement of the icon displayed on the display module at the first pointing mode when the detecting unit detects the second position where the second module slides relative to the first module and the remote control is in the vertically-oriented state.

12. The remote control system of claim 8, wherein the logic unit is used for performing the movement of the icon displayed on the display module at the first pointing mode when the detecting unit detects the first position where the second module slides relative to the first module and the remote control is in the horizontally-oriented state.

13. The remote control system of claim 1, wherein the logic unit is used for performing the movement of the icon displayed on the display module at the first pointing mode or at the second pointing mode according to how many times the third wireless transmission module receives the first pointing mode code or the second pointing mode code and the pointing mode relation information stored by the memory module.

14. The remote control system of claim 1, wherein the first wireless transmission module and the second wireless transmission module respectively transmits the wireless signals to the third wireless transmission module by infrared transmission technology.

15. The remote control system of claim 1, wherein the first wireless transmission module and the second wireless transmission module respectively transmits optical signals or audio signals with different frequencies to the third wireless transmission module.

16. A remote control method capable of switching different pointing modes, comprising:
a first wireless transmission module of a remote control transmitting a first wireless signal to an electronic device by wireless transmission technology, wherein the first wireless transmission signal comprises a first pointing mode code;
a second wireless transmission module of the remote control transmitting a second wireless signal to the electronic device by wireless transmission technology, wherein the second wireless transmission signal comprises a second pointing mode code; and
the electronic device performing movement of an icon at a first pointing mode or at a second pointing mode according to the first pointing mode code or the second pointing mode code and pointing mode relation information.

17. The remote control method of claim 16, wherein the first wireless transmission module is used for transmitting the first wireless signal in a first direction to the electronic device, the second wireless transmission module is used for transmitting the second signal in a second direction to the electronic device, the remote control is in a vertically-oriented state when the electronic device receives the first pointing mode code transmitted from the first wireless transmission module, and the remote control is in a horizontally-oriented state when the electronic device receives the second pointing mode code transmitted from the second wireless transmission module.

18. The remote control method of claim 17, wherein the first direction substantially differentiates from the second direction by 90 degrees, the vertically-oriented state substantially differentiates from the horizontally-oriented state by 90 degrees, and a performing direction of the first pointing mode code differentiates from that of the second pointing mode code by 90 degrees.

19. The remote control method of claim 17, further comprising a detecting unit detecting a first position or a second position where the second module slides relative to the first module, wherein the first position is a position where the second module and the first module are closed relatively, and the second position is a position where the second module and the first module are open relatively.

20. The remote control method of claim 19, wherein the electronic device is used for performing the movement of the icon displayed on the display module at the first pointing mode when the detecting unit detects the first position where the second module slides relative to the first module and the remote control is in the vertically-oriented state.

21. The remote control method of claim 19, wherein the electronic device is used for performing the movement of the icon displayed on the display module at the second pointing mode when the detecting unit detects the second position where the second module slides relative to the first module and the remote control is in the horizontally-oriented state.

22. The remote control method of claim 19, wherein the electronic device is used for performing the movement of the icon displayed on the display module at the first pointing mode when the detecting unit detects the second position where the second module slides relative to the first module and the remote control is in the vertically-oriented state.

23. The remote control method of claim 19, wherein the electronic device is used for performing the movement of the icon displayed on the display module at the first pointing mode when the detecting unit detects the first position where the second module slides relative to the first module and the remote control is in the horizontally-oriented state.

24. The remote control method of claim 16, wherein the electronic device performing the movement of the icon at the first pointing mode or at the second pointing mode according to the first pointing mode code or the second pointing mode code and the pointing mode relation information comprises performing the movement of the icon at the first pointing mode or at the second pointing mode according to how many times the electronic device receives the first pointing mode code or the second pointing mode code and the pointing mode relation information.

25. The remote control method of claim 16, wherein the first wireless transmission module and the second wireless transmission module respectively transmits the wireless signals to the electronic device by infrared transmission technology.

26. The remote control method of claim 16, wherein the first wireless transmission module and the second wireless transmission module respectively transmits optical signals or audio signals with different frequencies to the electronic device.
